(19) United States
(12) Patent Application Publication
(10) Pub. No.: US 2026/0045591 A1
(43) Pub. Date: Feb. 12, 2026

(54) MULTI-FUNCTIONAL COMPOSITE THERMAL BARRIER

(71) Applicant: GM Global Technology Operations LLC, Detroit, MI (US)

(72) Inventors: Seung-Woo Chu, Sterling Heights, MI (US); William Yu Chen, Troy, MI (US); Jian Zhang, Rochester Hills, MI (US); Ziliang Zheng, Auburn Hills, MI (US)

(21) Appl. No.: 18/796,502

(22) Filed: Aug. 7, 2024

(51) Int. Cl. H01M 10/658; F16L 59/02

(52) U.S. Cl. CPC H01M 10/658; F16L 59/029; H01M 2220/20

(57) ABSTRACT

A battery pack is provided. The battery pack includes at least one battery cell including a cathode, an anode, and an electrolyte that transports charged ions between the anode and the cathode. The battery pack includes a thermal barrier within the battery pack for shielding the at least one battery cell from thermal exposure. The thermal barrier includes a mica substrate, a first coating layer disposed on a first side of the mica substrate, and a second coating layer disposed on a second side of the mica substrate. The second side is distal from the first side. The first coating layer and the second coating layer is formed of aluminum tri hydroxide (ATH).

### INTRODUCTION

The present disclosure relates to a battery pack, and more particularly, to a multi-functional thermal barrier within the battery pack.

Rechargeable batteries are used in consumer electronic applications from small electronic devices, like cell phones and laptop computers, to larger devices like vehicles. These rechargeable batteries employ specific chemistries to be repeatedly recharged and reused, therefore offering economic, environmental and ease-of-use benefits compared to disposable batteries.

A battery pack may include multiple rechargeable battery cells in close proximity to one another. Certain chemistries of rechargeable battery cells, such as lithium-ion cells, as well as external factors, may cause internal reaction rates to generate significant amounts of thermal energy. Such chemical reactions may cause more heat generated by the batteries than is effectively withdrawn. Exposure of a battery cell to elevated temperatures over prolonged periods may cause the battery cell to experience a thermal runaway event. A thermal runaway event starting within an individual cell may lead to heat spreading to adjacent cells in the module and cause the thermal runaway event to propagate and affect the entire battery array.

While prior art methods and systems attempt to minimize and prevent thermal runaway and propagation and may achieve their particular purpose, a need still exists for a new and improved rechargeable battery pack. Accordingly, a stable and efficient rechargeable battery pack is needed.

### SUMMARY

According to several aspects of the present disclosure, a battery pack is provided. The battery pack includes at least one battery cell including a cathode, an anode, and an electrolyte that transports charged ions between the anode and the cathode. The battery pack includes a thermal barrier within the battery pack for shielding the at least one battery cell from thermal exposure. The thermal barrier includes a mica substrate, a first coating layer disposed on a first side of the mica substrate, and a second coating layer disposed on a second side of the mica substrate. The second side is distal from the first side. The first coating layer and the second coating layer is formed of aluminum tri hydroxide (ATH).

In accordance with another aspect of the disclosure, the battery pack includes a first coating layer and a second coating layer that is equal to or greater than 50 wt.% aluminum tri hydroxide.

In accordance with another aspect of the disclosure, the battery pack includes at least one of a first coating layer or a second coating layer that includes a textured surface to increase surface area.

In accordance with another aspect of the disclosure, the battery pack includes a thermal barrier having a thickness greater than or equal to 100 microns (µm).

In accordance with another aspect of the disclosure, the battery pack includes a first coating layer and a second coating layer each having a thickness of greater than or equal to 20 microns (µm).

In accordance with another aspect of the disclosure, the battery pack includes a resin coating disposed within the mica substrate.

In accordance with another aspect of the disclosure, the battery pack includes an encapsulation layer that encapsulates at least a portion of the thermal barrier for improving vibration robustness and particulate control.

According to several aspects of the present disclosure, a battery pack is provided. The battery pack includes at least one battery cell including a cathode, an anode, and an electrolyte that transports charged ions between the anode and the cathode. The battery pack includes a thermal barrier within the battery pack for shielding the at least one battery cell from thermal exposure. The thermal barrier includes an aluminum tri hydroxide (ATH) layer, a first mica layer disposed on a first side of the aluminum tri hydroxide layer, and a second mica layer disposed on a second side of the aluminum tri hydroxide layer The second side is distal from the first side.

In accordance with another aspect of the disclosure, the battery pack includes an aluminum tri hydroxide layer equal to or greater than 50 wt.% aluminum tri hydroxide.

In accordance with another aspect of the disclosure, the battery pack includes a first mica layer and/or a second mica layer including a textured surface to increase surface area.

In accordance with another aspect of the disclosure, the battery pack includes a thermal barrier having a thickness greater than or equal to 100 microns (µm).

In accordance with another aspect of the disclosure, the battery pack includes a first mica layer and/or a second mica layer each having a thickness greater than or equal to 20 microns (µm).

In accordance with another aspect of the disclosure, the battery pack includes a resin coating disposed within at least one of the first mica layer or the second mica layer.

In accordance with another aspect of the disclosure, the battery pack includes an encapsulation layer that encapsulates at least a portion of the thermal barrier for improving vibration robustness and particulate control.

According to several aspects of the present disclosure, a method for forming a thermal barrier for use in a battery pack is provided. The method includes forming mica paper using mica powder, applying a resin on the mica paper, press-molding multiple resin-applied mica papers to form a mica substrate, applying an aluminum tri hydroxide (ATH) slurry to form at least one of a first coating layer or a second coating layer on the mica substrate, applying hot press molding to the mica substrate and the at least one first coating layer or the second coating layer to form a composite, and applying a protective coating layer over the composite.

In accordance with another aspect of the disclosure, the method includes a first coating layer and a second coating layer equal to or greater than 50 wt.% aluminum tri hydroxide.

In accordance with another aspect of the disclosure, the method includes tahe thermal barrier having a thickness greater than or equal to 100 microns (µm).

In accordance with another aspect of the disclosure, the method includes a first coating layer and/or a second coating layer each having a thickness of greater than or equal to 20 microns (µm).

In accordance with another aspect of the disclosure, the method includes trimming the thermal barrier to form at least one trimmed side.

In accordance with another aspect of the disclosure, the method includes applying a second protective layer to the at least one trimmed side.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view illustrating an example of a vehicle having a battery pack including a thermal barrier configured to prevent or minimize thermal runaway and propagation, in accordance with the present disclosure.

FIG. 2 is a perspective view illustrating an example of a battery cell contained in the battery pack shown in FIG. 1, where the battery cell has a thermal barrier, in accordance with the present disclosure.

FIG. 3A is a side cross section view illustrating the thermal barrier shown in FIGS. 1 and 2, where the thermal barrier includes a mica substrate, a first coating layer, a second coating layer, and an encapsulation layer, in accordance with the present disclosure.

FIG. 3B is a top view illustrating the thermal barrier shown in FIG. 3A, in accordance with the present disclosure.

FIG. 4 is a side cross section view illustrating the thermal barrier shown in FIGS. 1 and 2, where the thermal barrier includes a textured surface having a valley and ridge configuration, in accordance with the present disclosure.

FIG. 5 is a side cross section view illustrating the thermal barrier shown in FIGS. 1 and 2, where the thermal barrier includes a textured surface having a wave and peak configuration, in accordance with the present disclosure.

FIG. 6A is a side cross section view illustrating the thermal barrier shown in FIGS. 1 and 2, where the thermal barrier includes an aluminum tri hydroxide (ATH) layer, a first mica layer, a second mica layer, and an encapsulation layer, in accordance with the present disclosure.

FIG. 6B is a top view illustrating the thermal barrier shown in FIG. 3A, in accordance with the present disclosure.

FIG. 7 is a flowchart illustrating a method for forming the thermal barrier for use in a battery pack as shown in FIGS. 1 through 6B, in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The following description is merely exemplary in nature and is not intended to limit the present disclosure, application, or uses.

Some battery pack designs incorporate mineral sheets near a terminal area and near enclosure surfaces within the battery pack to prevent arc flash and thermal failure due to hot gases from the battery cells during a battery pack thermal event. Mica is often selected as a primary component because it is temperature resistant (e.g., >1200°C) and is a good electrical insulator. However, a battery pack with additional protection from thermal runaway and propagation is needed.

Accordingly, a battery pack having a thermal barrier for shielding battery cells from thermal exposure is disclosed herein. The disclosed thermal barrier is a multi-functional high-temperature resistant insulation sheet that also provides energy absorption from thermal runaway gas, which lowers propagation risk. The thermal barrier also functions to lower vent gas temperature and surface temperature within the battery pack (e.g., a rechargeable energy storage system (RESS)).

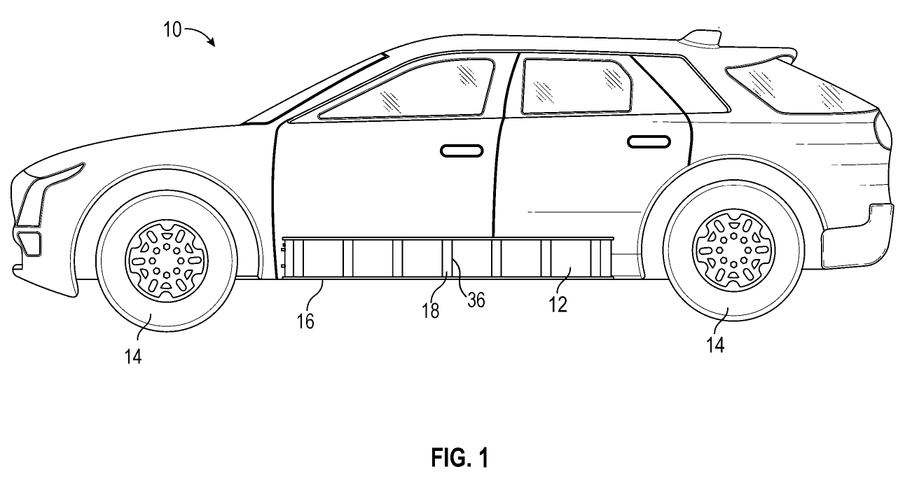

Referring to FIG.1, a perspective view of a vehicle 10 having a battery pack 12 is illustrated, in accordance with the present disclosure. The battery pack 12 is illustrated with an exemplary vehicle 10. The vehicle 10 is an electric vehicle or hybrid vehicle having wheels 14 driven by electric motors/inverters. The electric motors/inverters receive power from the battery pack 12. While the vehicle 10 is illustrated as a passenger road vehicle, it should be appreciated that the battery pack 12 may be used with various other types of vehicles. For example, the battery pack 12 may be used in nautical vehicles, such as boats, or aeronautical vehicles, such as drones or passenger airplanes. Moreover, the battery pack 12 may be used as a stationary power source separate and independent from a vehicle. Battery pack 12 includes a case 16 for supporting a plurality of battery cells 18. In an example, the battery pack 12 may have fifty or more battery cells 18.

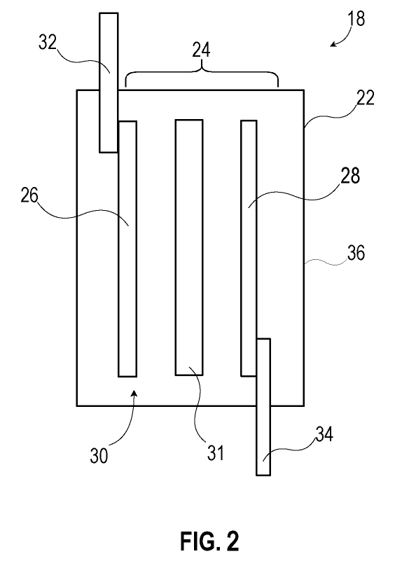

FIG. 2 illustrates one battery cell 18 within the battery pack 12 illustrated in FIG. 1. Each battery cell 18 disposed within the battery pack 12 shown in FIG. 1 has a housing 22 or case and at least one electrode stack 24, which further includes a cathode 26, an anode 28, an electrolyte 30, and/or a separator 31. Each battery cell 18 may have tens or hundreds of electrode stacks 24. Each electrode stack 24 is connected to a current collector 32, 34. The electrode stacks are placed in the housing 22, which are filled with an electrolyte 30. The electrolyte 30 transports ions between the cathode 26 and the anode 28. The current collectors 32, 34 are thin metal plates or foils disposed on sides of the electrode stacks 24 and/or housing 22 and typically have a thickness between 0.1 and 1 millimeter. The current collectors 32, 34 may be made of copper or aluminum and are attached to the electrode stacks 24 to transmit the electric current to an external circuit (not shown).

As shown in FIG. 1, the battery pack 12 includes a thermal barrier 36. The thermal barrier 36 may be disposed proximate a terminal area and/or other enclosure or surfaces of the housing 22 for shielding the at least one battery cells 18 from thermal exposure. The thermal barrier 36 is configured to prevent arc flash and thermal failure due to hot gases from thermal runaway and propagation. The thermal barrier 36 may be a variety of thicknesses. In an example, a thickness of the thermal barrier 36 is greater than or equal to 100 microns (µm). The thermal barrier 36 includes a mica substrate 38, a first coating layer 40, and a second coating layer 42.

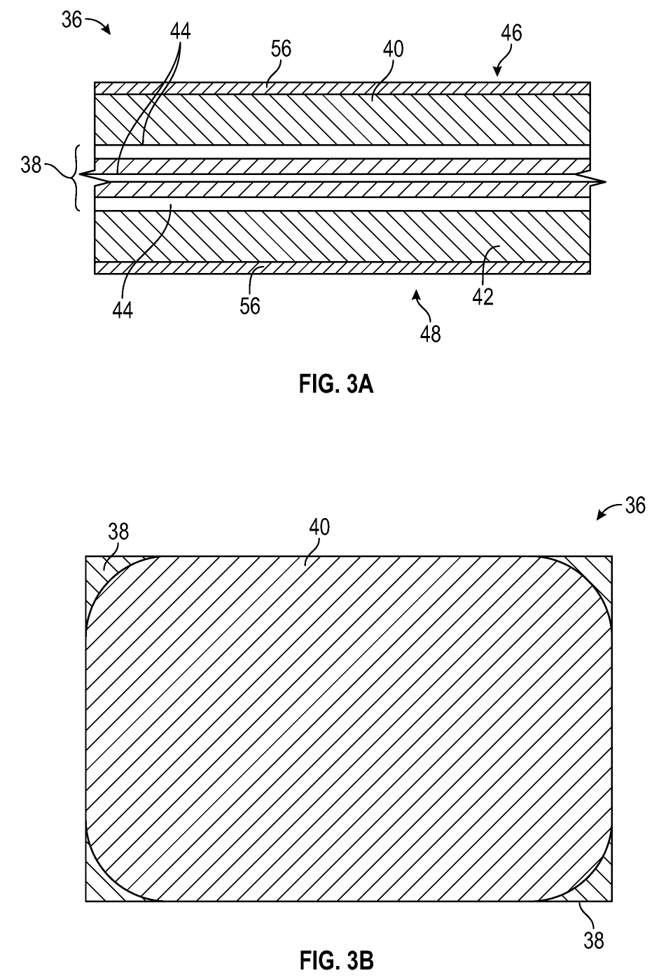

Depicted in FIGS. 3A and 3B, the thermal barrier 36 includes the mica substrate 38. The mica substrate 38 may be formed substantially or completely of mica. Mica is a group of silicate minerals easily split into thin, elastic plates due to their perfect basal cleavage. The mica substrate 38 can be in the form of one or more mica sheets or mica papers, which may include multiple layers of mica each separated by a thin resin layer 44. Mica is chosen as a primary component because it is temperature resistant at high temperatures (i.e. up to about 1000°C in pure form and 1600°C in build-up form). Additionally, mica has a dielectric strength between 10 to 25 kilovolts per millimeter (kV/mm) making it an excellent electrical insulator against high voltages and arcing. Additionally, mica is mechanically and chemically stable in micrometer-thin sheets while being impervious to most gases.

Still referring to FIGS. 3A and 3B, a first coating layer 40 is disposed on a first side 46 of the mica substrate 38, and a second coating layer 42 is disposed on a second side 48 of the mica substrate 38. The first coating layer 40 and the second coating layer 42 are formed at least partially of aluminum tri hydroxide (ATH). When subjected to extreme heat, aluminum tri hydroxide (ATH) chemically breaks down into metal oxide and water. Accordingly, the aluminum tri hydroxide (ATH) is configured to undergo a chemical decomposition and discharge moisture (i.e., water molecules (H₂O)) in response to significant thermal energy in the form of thermal runaway gases being released within the battery pack 12. The released thermal energy generally correlates to a temperature of the battery cell 18 exceeding a predetermined value t_{c}. A temperature in excess of the predetermined value t_{c} is indicative of a battery cell experiencing a thermal runaway event. In one example, the predetermined value t_{c} may be about 200 degrees Celsius, and a temperature in excess of 200°C may indicate a thermal runaway event. The term “about” is understood by one skilled in the art. Alternatively, the term “about” is defined as plus or minus 5°C. Water molecules (H₂O) discharged from the aluminum tri hydroxide (ATH) in the first coating layer 40 and/or the second coating layer 42 removes thermal energy from the surface of the thermal barrier 36 and/or nearby components, such as the battery cells 18, via evaporation. The discharge of the water molecules by the aluminum tri hydroxide (ATH) in the first coating layer 40 and/or the second coating layer 42 is thereby configured to prevent or minimize propagation of the thermal runaway event to neighboring battery cells.

The first coating layer 40 and/or the second coating layer 42 may formed on and coupled to the mica substrate 38 or may be a pre-formed sheet disposed on and coupled to the mica substrate 38. Additionally, the first coating layer 40 and/or the second coating layer 42 may be formed by using a compression molding process. When using the compression molding process, the first coating layer 40 and/or the second coating layer 42 can include an ATH layer using cellulose as a binder, and the ATH layer is attached to the mica substrate 38 using an adhesive. In an example, the first coating layer 40 and the second coating layer 42 are equal to or greater than 50 wt.% aluminum tri hydroxide (ATH) (e.g., 50 wt.%, 55 wt.%, 60 wt.%, and so forth). When the first coating layer 40 and the second coating layer 42 including the aluminum tri hydroxide (ATH) is disposed on the mica substrate 38, one suitable location within the battery pack 12 is within a venting gas pathway.

Some additional components of the first coating layer 40 and the second coating layer 42 may include binders or bonding agents. For example, the first coating layer 40 and/or the second coating layer 42 may include starch (as a bonding agent), cellulose, and/or a polymer blended with aluminum tri hydroxide (ATH) at 1-10 wt.% to promote dimensional stability and mechanical strength of the first coating layer 40 and/or the second coating layer 42. Additionally, and to further enhance mechanical strength of the first coating layer 40 and/or the second coating layer 42, the aluminum tri hydroxide (ATH) may include an alternative bonding agent, for example a resin (e.g., silicon-based) at 1-10% wt.%.

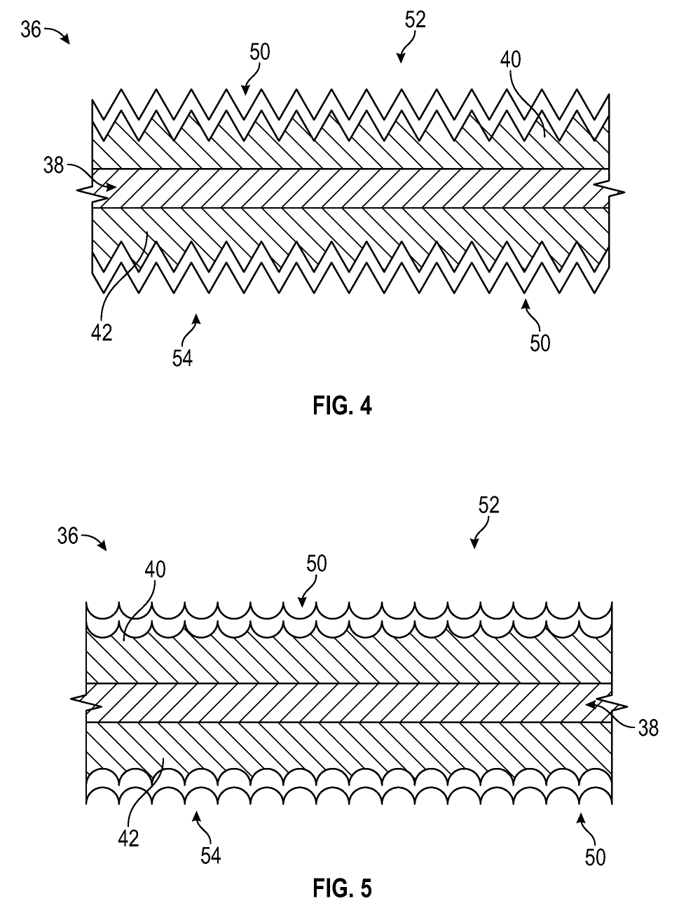

Referring to FIGS. 4 and 5, the thermal barrier 36 may have a textured surface 50. As shown in FIG. 4, the first coating layer 40 and the second coating layer 42 are formed so that a first outside surface 52 (e.g., distal from the mica substrate 38) and/or a second outside surface 54 (distal from the mica substrate 38) has a series of repeating ridges and sharp valleys. As shown in FIG. 5, the first coating layer 40 and the second coating layer 42 are formed so that an outside surface 52,54 (e.g., distal from the mica substrate 38) has a series of repeating peaks and rounded valleys. It will be appreciated that the first outside surface 52 and/or the second outside surface 54 may have additional or other forms of textured surface 50, for example divots, dimples, grooves, recesses, and the like. The textured surface 50 is configured to increase a surface area of the first coating layer 40 and the second coating layer 42. The increased surface area serves to absorb thermal energy faster and facilitate and promote an endothermic reaction between the heated gas and the first coating layer 40 and the second coating layer 42 including decomposition of the aluminum tri hydroxide (ATH) within the first coating layer 40 and the second coating layer 42.

In some instances, and as depicted in FIG. 3A, the thermal barrier 36 may include an encapsulation layer 56 disposed on the first coating layer 40 and/or the second coating layer 42. The encapsulation layer 56 may include a protective polymer (e.g., polyurethane, epoxy) configured to cover at least a portion of the thermal barrier 36 and to provide particulate control and/or vibration robustness. During a thermal runaway event, and when exposed to hot gases from the thermal runaway event, the encapsulation layer 56 is configured to be thin enough that energy in the form of heat melts and/or destroys the encapsulation layer 56 so that the first coating layer 40 and the second coating layer 42 is at least partially exposed to the hot gases and the aluminum tri hydroxide (ATH) can decompose into metal hydroxide and water.

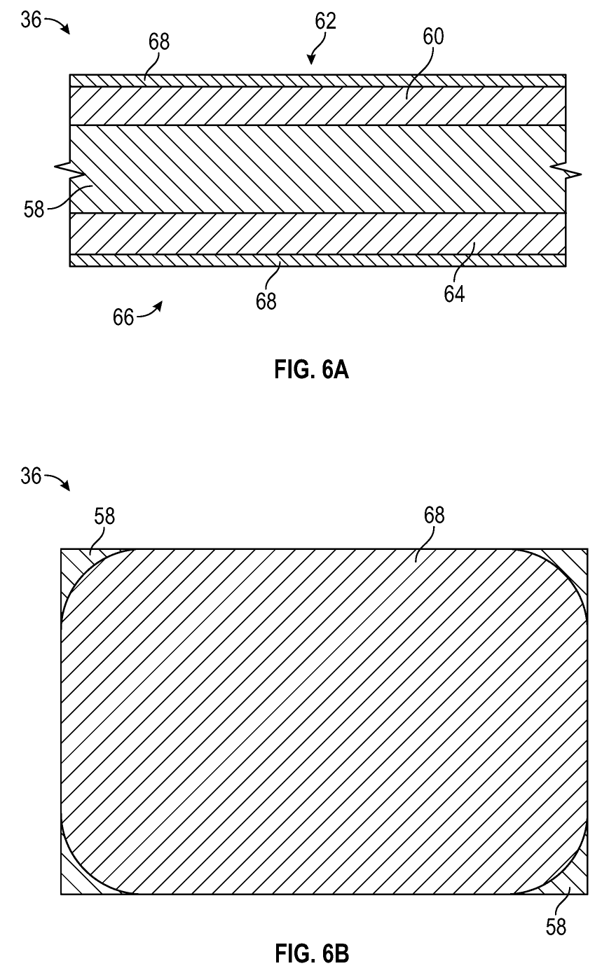

Referring to FIGS. 6A and 6B, the thermal barrier 36 may have a reverse configuration. In this configuration, the thermal barrier 36 includes an aluminum tri hydroxide (ATH) layer 58. The aluminum tri hydroxide (ATH) layer 58 may be similar to the first coating layer 40 and the second coating layer 42 described previously. The aluminum tri hydroxide (ATH) layer 58 includes at least 50 wt.% aluminum tri hydroxide (ATH) (e.g., 50 wt.%, 55 wt.%, 60 wt.%, and so forth).

Still referring to FIGS. 6A and 6B, a first mica layer 60 is disposed on a first side 62 of the aluminum tri hydroxide (ATH) layer 58, and a second mica layer 64 is disposed on a second side 66 of the aluminum tri hydroxide (ATH) layer 58. The first side 62 is opposite the second side 66. The first mica layer 60 and/or the second mica layer 64 may be thin so that when the thermal barrier 36 is exposed to heat (e.g., thermal runaway gases), the first mica layer 60 and/or the second mica layer 64 may be compromised and the aluminum tri hydroxide (ATH) layer 58 may be exposed to the thermal runaway gases. For example, the first mica layer 60 and/or the second mica layer 64 may each be greater than or equal to about 20 microns (µm). In this context, the term “about” is known to those of skill in the art. Alternatively, the term “about” means plu or minus 1 micron (µm). In some instances, an encapsulation layer 68 is disposed on and coupled to at least one of the first mica layer 60 or the second mica layer 64. The encapsulation layer 68 may be similar to the encapsulation layer 56 previously described. When the thermal barrier 36 includes the first mica layer 60 and the second mica layer 64 disposed on the aluminum tri hydroxide (ATH) layer 58, one suitable location of the thermal barrier 36 within the battery pack 12 may be proximate a high voltage bus bar.

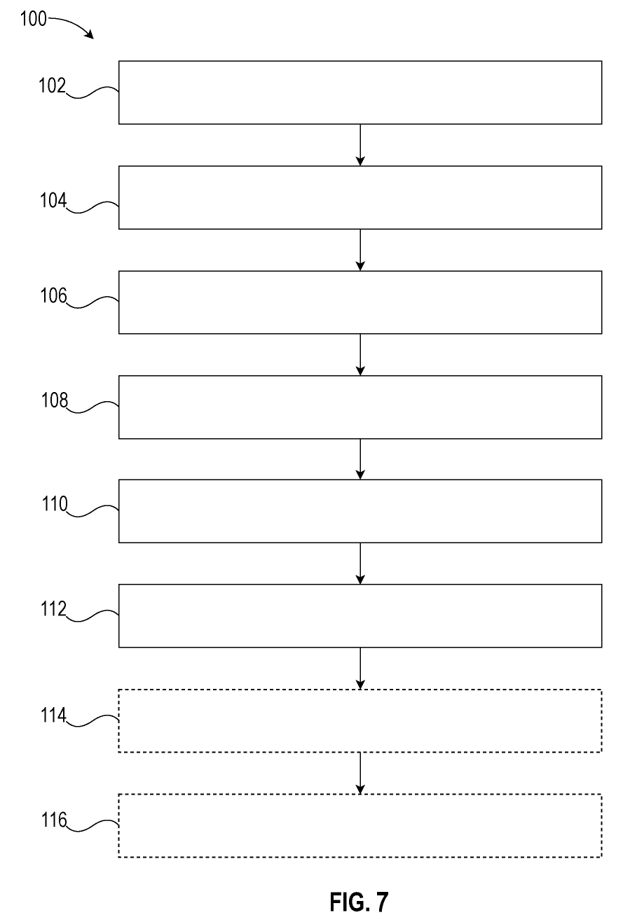

With reference to FIG. 7, a method 100 for forming the thermal barrier 36 for use in a battery pack 12 is presented, in accordance with the present disclosure. The method starts at block 102.

Block 102 depicts forming mica paper using mica powder. Forming the mica paper may include using high-quality mica powder or flakes, for example muscovite, phlogopite, synthetic mica, or calcined muscovite, which may be selected and cleaned to remove impurities. The clean mica powder or flakes are mixed with a binder, typically a combination of resins, to create a homogeneous mixture. This homogenous mixture is then pressed and heated to form a solid sheet of mica paper. The pressing and heating process can be adjusted to achieve the desired thickness and properties of the mica paper.

Block 104 depicts applying a resin (e.g., resin layer 44) on at least one side of the mica paper. Multiple layers of mica paper can be stacked together using a resin layer 44 between the layers of mica paper.

Block 106 depicts press-molding the multiple resin-applied mica papers to form a mica substrate 38. Press-molding includes a manufacturing process where the layers of mica paper, often preheated, are placed into an open, heated mold cavity. The mold is then closed with a top force or plug member, and pressure is applied to apply force to the mica papers into contact with all areas of the mold. Heat and pressure are maintained until the mold papers have cured forming the mica substrate 38.

Block 108 depicts applying aluminum tri hydroxide (ATH) slurry to form at least one of a first coating layer 40 or a second coating layer 42 on the mica substrate 38. The slurry may be in the form of aluminum tri hydroxide (ATH) powder or particles suspended in a liquid and may be brushed, sprayed, dipped, and the like, onto the mica substrate 38. In some instances, the aluminum tri hydroxide (ATH) slurry may be cured, for example by air drying or applying heat to form the first coating layer 40, the second coating layer 42, and/or the aluminum tri hydroxide (ATH) layer 58.

Block 110 depicts applying hot press molding to the mica substrate and the at least one first coating layer 40 (of aluminum tri hydroxide (ATH)) or the second coating layer 42 (of aluminum tri hydroxide (ATH)) to form a composite (e.g., thermal barrier 36). The composite is placed into an open, heated mold cavity. The mold is then closed with a top force or plug member, and pressure is applied to apply force to the composite into contact with all areas of the mold. Heat and pressure are maintained so that the composite displays improved dimensional stability, improved adhesion, and texture formation on an outer surface of the composite.

Block 112 depicts applying protective coating layer over the outer surface of the composite to form an encapsulation layer 56. The encapsulation layer 56 may include various polymers (e.g., polyurethane) or other protective materials configured to protect the composite (e.g., thermal barrier 36) from environmental factors, for example particulate matter.

In some instances, and as depicted in block 114, the composite or thermal barrier 36 may be subsequently trimmed in a desired dimension. Additionally, and as depicted in block 116, a thin protective coating (e.g., a material similar to the encapsulation layer 56) may be applied to any cut side of the thermal barrier, for example a side cut during a trimming step. The thin protective coating may include thin polyethylene bags or films to prevent particle contamination during assembly.

The thermal barrier 36 of the present disclosure is advantageous and beneficial over prior art solutions. The thermal barrier 36 is a multi-functional high-temperature resistant insulation sheet that also provides energy absorption from thermal runaway gas, which lowers propagation risk. The thermal barrier 36 also functions to lower vent gas temperature and surface temperature within the battery pack 12 (e.g., a rechargeable energy storage system (RESS)). When the thermal barrier 36 is exposed to heat from thermal runaway gases, the heat causes the aluminum tri hydroxide (ATH) to decomposed into metal oxide and water, where the water removes thermal energy via evaporation.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A battery pack, comprising:
at least one battery cell including
a cathode;
an anode; and
an electrolyte that transports charged ions between the anode and the cathode; and
a thermal barrier within the battery pack for shielding the at least one battery cell from thermal exposure, the thermal barrier including
a mica substrate;
a first coating layer disposed on a first side of the mica substrate, wherein the first coating layer is formed at least partially of aluminum tri hydroxide (ATH); and
a second coating layer disposed on a second side of the mica substrate, wherein the second side is distal from the first side, and wherein the second coating layer is formed of aluminum tri hydroxide (ATH).

2. The battery pack of claim 1, wherein the first coating layer and the second coating layer is equal to or greater than 50 wt.% aluminum tri hydroxide.

3. The battery pack of claim 1, wherein at least one of the first coating layer or the second coating layer includes a textured surface to increase surface area.

4. The battery pack of claim 1, wherein a thickness of the thermal barrier is greater than or equal to 100 microns (µm).

5. The battery pack of claim 1, wherein a thickness of each of the first coating layer and the second coating layer is greater than or equal to 20 microns (µm).

6. The battery pack of claim 1, further comprising:
a resin coating disposed within the mica substrate.

7. The battery pack of claim 1, further comprising:
an encapsulation layer that encapsulates at least a portion of the thermal barrier for improving vibration robustness and particulate control.

8. A battery pack, comprising:
at least one battery cell including
a cathode;
an anode; and
an electrolyte that transports charged ions between the anode and the cathode; and
a thermal barrier within the battery pack for shielding the at least one battery cell from thermal exposure, the thermal barrier including
an aluminum tri hydroxide (ATH) layer;
a first mica layer disposed on a first side of the aluminum tri hydroxide layer; and
a second mica layer disposed on a second side of the aluminum tri hydroxide layer, wherein the second side is distal from the first side.

9. The battery pack of claim 8, wherein the aluminum tri hydroxide layer is equal to or greater than 50 wt.% aluminum tri hydroxide.

10. The battery pack of claim 8, wherein at least one of the first mica layer or the second mica layer includes a textured surface to increase surface area.

11. The battery pack of claim 8, wherein a thickness of the thermal barrier is greater than or equal to 100 microns (µm).

12. The battery pack of claim 8, wherein a thickness of each of the first mica layer and the second mica layer is greater than or equal to 20 microns (µm).

13. The battery pack of claim 8, further comprising:
a resin coating disposed within at least one of the first mica layer or the second mica layer.

14. The battery pack of claim 8, further comprising:
an encapsulation layer that encapsulates at least a portion of the thermal barrier for improving vibration robustness and particulate control.

15. A method for forming a thermal barrier for use in a battery pack, comprising:
forming mica paper using mica powder;
applying a resin on the mica paper;
press-molding multiple resin-applied mica papers to form a mica substrate;
applying an aluminum tri hydroxide (ATH) slurry to form at least one of a first coating layer or a second coating layer on the mica substrate;
applying hot press molding to the mica substrate and the at least one first coating layer or the second coating layer to form a composite; and
applying a protective coating layer over the composite.

16. The method of claim 15, wherein the first coating layer and the second coating layer is equal to or greater than 50 wt.% aluminum tri hydroxide.

17. The method of claim 15, wherein a thickness of the thermal barrier is greater than or equal to 100 microns (µm).

18. The method of claim 15, wherein a thickness of each of the first coating layer and the second coating layer is greater than or equal to 20 microns (µm).

19. The method of claim 15, further comprising:
trimming the thermal barrier to form at least one trimmed side.

20. The method of claim 19, further comprising:
applying a second protective layer to the at least one trimmed side.
